(19) United States
(12) Patent Application Publication
(10) Pub. No.: US 2026/0120380 A1
(43) Pub. Date: Apr. 30, 2026

(54) KINETIC TYPOGRAPHY VIDEO GENERATION SYSTEM AND CONTROL METHOD THEREOF, AND LEARNING METHOD OF KINETIC TYPOGRAPHY VIDEO GENERATION SYSTEM

(71) Applicant: GWANGJU INSTITUTE OF SCIENCE AND TECHNOLOGY, Gwangju (KR)

(72) Inventors: Seon mi PARK, Gwangju (KR); Hae Gon JEON, Gwangju (KR); In Hwan BAE, Gwangju (KR); Seung Hyun SHIN, Gwangju (KR)

(73) Assignee: GWANGJU INSTITUTE OF SCIENCE AND TECHNOLOGY, Gwangju (KR)

(21) Appl. No.: 19/366,853

(22) Filed: Oct. 23, 2025

(30) Foreign Application Priority Data
Oct. 29, 2024 (KR) 10-2024-0149357

(51) Int. Cl. G06T 13/80; G06F 40/109

(52) U.S. Cl. CPC G06T 13/80; G06F 40/109

(57) ABSTRACT

A kinetic typography video generation system, a control method and a learning method. According to the method, a typography video to be trained is inputted into an encoder; a latent vector for the video is acquired from the encoder; the latent vector is inputted into temporal-spatial processing blocks that process spatial information and temporal information; a static caption and a dynamic caption for text included in the video is injected into the temporal-spatial processing blocks; a latent vector reflecting the spatial information and a latent vector reflecting the temporal information from the temporal-spatial processing blocks is acquired; the latent vector reflecting the spatial information and the latent vector reflecting the temporal information is inputted into a decoder; a final typography video for the input from the decoder is acquired; and a typography generation model using the final typography video and the typography video is trained.

### CROSS REFERENCE TO RELATED APPLICATION

The present application claims priority to Korean Patent Application No. 10-2024-0149357, filed on Oct. 29, 2024, the entire contents of which are hereby incorporated by reference in its entirety.

### STATEMENT REGARDING PRIOR DISCLOSURES BY THE INVENTOR OR A JOINT INVENTOR

Prior disclosure related to the present application was made by inventors of the present application in journal paper entitled “Kinetic Typography Diffusion Model” on Jul. 15, 2024. A copy of the journal paper is provided on a concurrently filed Information Disclosure Statement.

### BACKGROUND

### Field of the Invention

The present invention relates to a kinetic typography video generation system, a control method thereof, and a learning method of the kinetic typography video generation system. More specifically, the present invention relates to a learning method for the kinetic typography video generation model of a typography video generation system.

### Description of the Related Art

Kinetic typography is a dynamic motion graphic design and a technology that uses visual effects of text movement within a video to convey information. The main goal of kinetic typography is to make the message visually noticeable and to enhance the memorability of the message. For example, it includes the way text appears or moves on the screen in advertisements or movie openings.

Such kinetic typography adjusts the shape (glyph), color, and texture of the text over time and transforms the corresponding position. Conventionally, designers generated kinetic typography videos by manually setting the shape, color, and position of text and applying animation effects using commercial software (e.g., Adobe After Effects). However, this process is time-consuming and involves the difficulty of performing complex procedures.

Meanwhile, with the recent advancements in artificial intelligence, research has been actively conducted to automate the process of generating kinetic typography videos using AI-based generation models.

However, conventional research focuses on applying styles to individual characters or generating multiple characters at once. Further, conventional research focuses solely on animation effects without actual movement of the characters. Such methods have the drawback of being difficult to move or edit the characters individually. That is, conventional generation models are not specialized for kinetic typography as they lack an understanding of the shape and movement of characters during video generation, and because all characters are generated together, editing individual characters or applying animation effects is limited.

Therefore, the present invention proposes a method of automatically generating visually attractive and readable kinetic typography videos, addressing various elements such as the shape, color, size, position, and movement of the characters.

### SUMMARY

The present invention is directed to providing a kinetic typography video generation system capable of automatically generating kinetic typography videos, a control method thereof, and a learning method of the kinetic typography video generation system.

More specifically, the present invention is directed to providing a kinetic typography video generation model capable of generating a kinetic typography video based on a text prompt input by a user.

Further, the present invention is directed to providing a learning method of a kinetic typography video generation model capable of enabling dynamic movement and style transformation of multiple characters and generating a more sophisticated and flexible kinetic typography video.

In order to solve the aforementioned objects, there is provided a method according to the present invention. The method may include: inputting a typography video to be trained into an encoder; acquiring a latent vector for the video from the encoder; inputting the latent vector into temporal-spatial processing blocks that process spatial information and temporal information; injecting a static caption and a dynamic caption for text included in the video into the temporal-spatial processing blocks; acquiring a latent vector reflecting the spatial information and a latent vector reflecting the temporal information from the temporal-spatial processing blocks; inputting the latent vector reflecting the spatial information and the latent vector reflecting the temporal information into a decoder; acquiring a final typography video for the input from the decoder; and training a typography generation model using the final typography video and the typography video to be trained.

Further, the temporal-spatial processing blocks may include a spatial block for processing the spatial information and a temporal block for processing the temporal information, and the spatial block and the temporal block may exist to form a pair.

Further, the injecting may include: injecting the static caption describing the spatial information of the text into the spatial block; and injecting the dynamic caption describing the temporal information of the text into the temporal block, in which the static caption may include a description of at least one of a visual external appearance of the text or a characteristic of a background included in the video, and the dynamic caption may include a description of at least one of a motion, an appearance order, and a change pattern of the text according to a temporal change of the video.

Further, the spatial block may include a spatial downsampling block and a spatial upsampling block, and the temporal block may include a temporal downsampling block and a temporal upsampling block.

Further, the injecting may further include injecting a word caption for the text into the temporal-spatial processing blocks, and the word caption may include a description of an overall structure and meaning of the text.

Further, the injecting of the word caption may include: specifying at least one block among the temporal-spatial processing blocks into which the word caption is to be injected and injecting the word caption into the specified block.

Further, the spatial block may output a latent vector reflecting the spatial information through a preset spatial diffusion mechanism, the temporal block may output a latent vector reflecting the temporal information through a preset temporal diffusion mechanism, and the decoder may generate the final typography video by combining the latent vectors respectively output from the spatial block and the temporal block.

Further, the training may include: calculating a loss between the typography video to be trained and the final typography video generated by the decoder using a preset loss function; and training the typography generation model such that the loss is reduced.

Meanwhile, there is provided a kinetic typography video generation system, according to the present invention. The kinetic typography video generation system may include a memory and at least one processor, in which the memory and the processor may cooperate to: input a typography video to be trained into an encoder; acquire a latent vector for the video from the encoder; input the latent vector into temporal-spatial processing blocks that process spatial information and temporal information; inject a static caption and a dynamic caption for text included in the video into the temporal-spatial processing blocks; acquire a latent vector reflecting the spatial information and a latent vector reflecting the temporal information from the temporal-spatial processing blocks; input the latent vector reflecting the spatial information and the latent vector reflecting the temporal information into a decoder; acquire a final typography video for the input from the decoder; and train a typography generation model using the final typography video and the typography video to be trained.

Meanwhile, there is provided a program stored in a computer-readable recording medium, which is executed by one or more processes in an electronic device, according to the present invention. The program may include instructions to perform: inputting a typography video to be trained into an encoder; acquiring a latent vector for the video from the encoder; inputting the latent vector into temporal-spatial processing blocks that process spatial information and temporal information; injecting a static caption and a dynamic caption for text included in the video into the temporal-spatial processing blocks; acquiring a latent vector reflecting the spatial information and a latent vector reflecting the temporal information from the temporal-spatial processing blocks; inputting the latent vector reflecting the spatial information and the latent vector reflecting the temporal information into a decoder; acquiring a final typography video for the input from the decoder; and training a typography generation model using the final typography video and the typography video to be trained.

As described above, according to the kinetic typography video generation system and the control method thereof, and the learning method of the kinetic typography video generation system according to the present invention, by automatically generating a kinetic typography video using a kinetic typography video generation model, a user environment may be provided in which a kinetic typography video that matches the user's intent may be generated without requiring manual work by the user. That is, without requiring the user to perform manual processing, a high-quality kinetic typography video may be generated automatically, thereby enabling the user to generate a kinetic typography video matching the user's intent efficiently without wasting time or resources.

In addition, according to the kinetic typography video generation system, the control method thereof, and the learning method of the kinetic typography video generation system according to the present invention, by enabling dynamic movement and style transformation of multiple characters, a more sophisticated and flexible kinetic typography video may be generated.

Further, according to the kinetic typography video generation system, the control method thereof, and the learning method of the kinetic typography video generation system according to the present invention, by systematically separating and labeling static and dynamic effects, the kinetic typography video generation model may better understand the visual external appearance and movement of text, thereby generating a more sophisticated and flexible kinetic typography video.

In addition, according to the kinetic typography video generation system, the control method thereof, and the learning method of the kinetic typography video generation system according to the present invention, by training the kinetic typography video generation model using various captions along with the video, the kinetic typography video generation model may not only maintain temporal consistency but also more accurately express character-specific motion effects suitable for the text prompt.

Furthermore, according to the kinetic typography video generation system, the control method thereof, and the learning method of the kinetic typography video generation system according to the present invention, by utilizing the static caption, dynamic caption, and word caption, visual external shape and temporal motion may be more precisely controlled. Through this, it is possible to implement typography that is not a simple text video but is customizable, eye-catching, and high in deliverability.

That is, in the present invention, by dividing the text prompt into a static caption and a dynamic caption and respectively learning and processing them by separating spatial and temporal information, the readability of the text is improved and accurate motion expression becomes possible. As a result, customized typography video generation according to user requirements may be achieved, and even after generating the typography video, functionality may be provided to allow the user to flexibly modify text style, color, motion, and the like. Additionally, the model structure of the present invention enables harmonious combination of various information, providing effective visual expression for message delivery. Particularly, the present invention may generate typography videos capable of attracting viewers' attention and clearly delivering information in content such as advertisements, movie titles, and educational materials.

### BRIEF DESCRIPTION OF THE DRAWINGS

FIG. 1 is a conceptual diagram for explaining a kinetic typography video generation system according to the present invention.

FIG. 2 is a conceptual diagram for explaining a kinetic typography training dataset according to the present invention.

FIG. 3 is a flowchart for explaining a learning method of the kinetic typography video generation system according to the present invention.

FIGS. 4, 5A to 5D, and 6A to 6E are conceptual diagrams for explaining the learning method of the kinetic typography video generation system according to the present invention.

FIG. 7 is a block diagram illustrating an embodiment of a computing system in which the present invention can be implemented.

FIGS. 8 and 9 are block diagrams illustrating an embodiment of a computing device according to the present invention.

### DETAILED DESCRIPTION

Hereinafter, exemplary embodiments disclosed in the present specification will be described in detail with reference to the accompanying drawings. The same or similar constituent elements are assigned with the same reference numerals regardless of reference numerals, and the repetitive description thereof will be omitted. The suffixes “module”, “unit”, “part”, and “portion” used to describe constituent elements in the following description are used together or interchangeably in order to facilitate the description, but the suffixes themselves do not have distinguishable meanings or functions. In addition, in the description of the exemplary embodiment disclosed in the present specification, the specific descriptions of publicly known related technologies will be omitted when it is determined that the specific descriptions may obscure the subject matter of the exemplary embodiment disclosed in the present specification. In addition, it should be interpreted that the accompanying drawings are provided only to allow those skilled in the art to easily understand the embodiments disclosed in the present specification, and the technical spirit disclosed in the present specification is not limited by the accompanying drawings, and includes all alterations, equivalents, and alternatives that are included in the spirit and the technical scope of the present invention.

The terms including ordinal numbers such as “first,” “second,” and the like may be used to describe various constituent elements, but the constituent elements are not limited by the terms. These terms are used only to distinguish one constituent element from another constituent element.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element exists between the constituent elements.

Singular expressions include plural expressions unless clearly described as different meanings in the context.

In the present application, it should be understood that terms “including” and “having” are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance.

The present invention relates to a kinetic typography video generation system, a control method thereof, and a learning method of the kinetic typography video generation system. The kinetic typography video generation system according to the present invention may be a system for generating kinetic typography videos from text. Further, the kinetic typography video generation system according to the present invention may be a system for generating kinetic typography videos that correspond to conditions requested by the user.

The kinetic typography video generation system according to the present invention includes a kinetic typography video generation model, and the present invention aims to provide a kinetic typography video generation model that enables dynamic movement and style transformation of multiple characters, allowing for the automatic generation of more sophisticated and flexible kinetic typography videos.

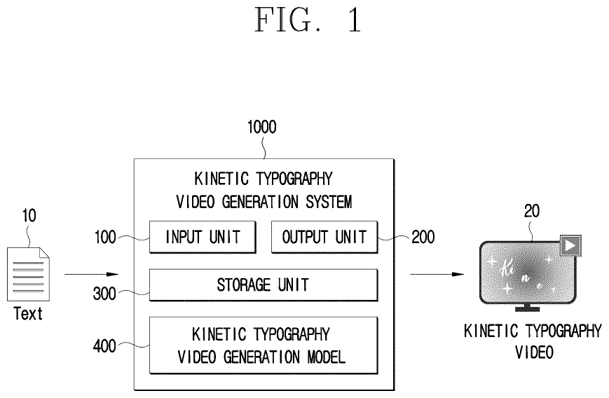

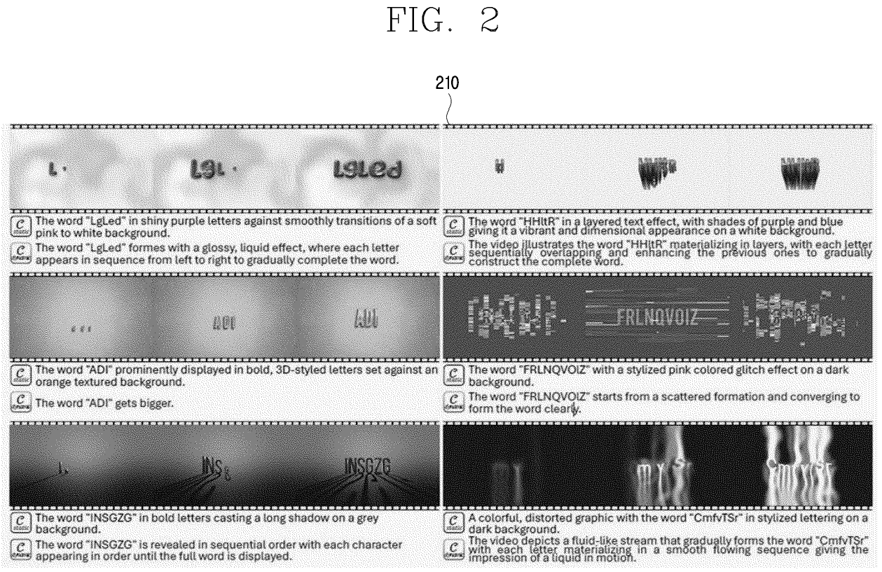

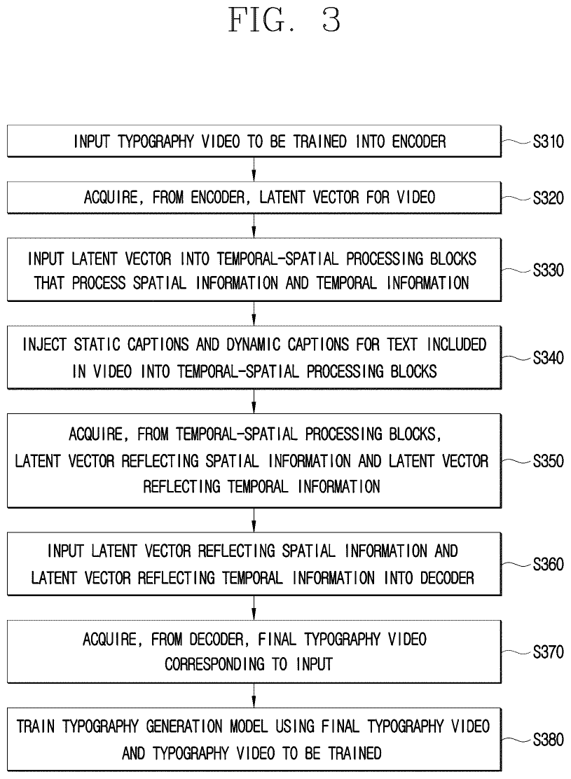

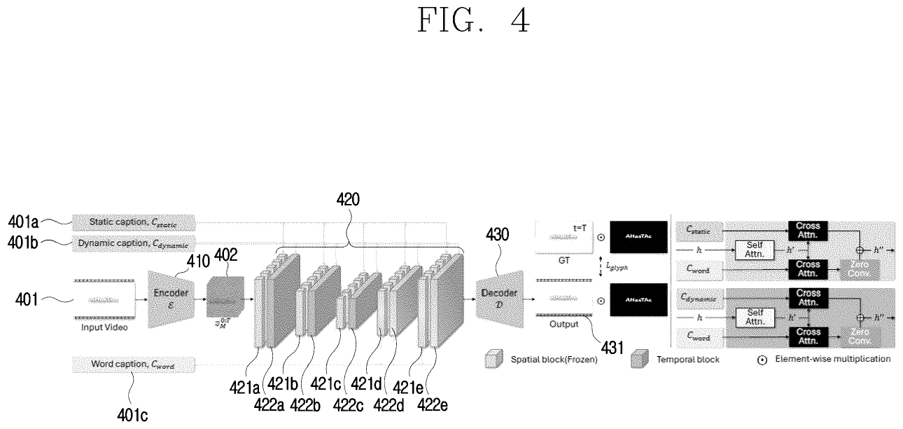

Hereinafter, the present invention will be described in more detail with reference to the accompanying drawings. FIG. 1 is a conceptual diagram for explaining a kinetic typography video generation system according to the present invention. FIG. 2 is a conceptual diagram for explaining a kinetic typography training dataset according to the present invention. Further, FIG. 3 is a flowchart for explaining a learning method of the kinetic typography video generation system according to the present invention, and FIGS. 4, 5A to 5D, and 6A to 6E are conceptual diagrams for explaining the learning method of the kinetic typography video generation system according to the present invention.

First, as illustrated in FIG. 1, the kinetic typography video generation system 1000 according to the present invention may include at least one of an input unit 100, an output unit 200, a storage unit 300, or a kinetic typography video generation model 400.

Although not illustrated, the kinetic typography video generation system 1000 according to the present invention may include one or more processors, and these processors may include one or more general-purpose processors and/or one or more specialized processors (for example, a digital signal processor, a tensor processing unit (TPU), a graphics processing unit (GPU), a neural network processing unit (NPU), an application-specific integrated circuit (ASIC), etc.). The one or more processors may be configured to execute instructions, computer-readable directives, and/or other instructions described in the present specification, which are stored (or included) in the storage unit 300. The kinetic typography video generation system and method according to the present invention may perform data processing, as described below, with the cooperation of a memory and at least one processor. The processor may perform a series of operations and data processing using data and information stored in the memory. In this case, the memory may be a component of the storage unit 300.

Meanwhile, the input unit 100 may serve as a means for data input, and may be configured in various types. For example, the input unit 100 may be configured to receive a user input. The input unit 100 may be configured to receive a user input from a user terminal. Here, the phrase “receives input” may mean receiving an input signal (or selection signal) corresponding to user input, based on input being made by a user through an input unit configuration provided in the user terminal.

In addition, in the present invention, the input unit 100 does not necessarily refer to a hardware means, but may be understood as a channel for receiving input from a user.

The input unit 100 may also be referred to as a user interface module. The input unit 100 may include a touch screen, computer mouse, keyboard, keypad, touch pad, trackball, joystick, voice recognition module, or other similar devices. However, in the present invention, the types of the input unit 100 are not limited.

Here, the user input may include a document, text, image (or video), voice, and the like. In this case, the kinetic typography video generation system 1000 may further include a module for converting voice into text.

Next, the output unit 200 may output information through an output unit configuration (e.g., a display unit, touch screen, speaker, etc.) provided in a user terminal interlocked with the kinetic typography video generation system 1000 according to the present invention. For example, the output unit 200 may output a page (or service page) linked with the kinetic typography video generation system 1000 according to the present invention to a display unit of the user terminal. In addition, the output unit 200 does not necessarily refer to a hardware means, but may be understood as a channel for outputting results to a user.

Meanwhile, the storage unit 300 may perform a role of storing various data related to the present invention, and may include one or more non-transitory computer-readable storage media that may be read and/or accessed by at least one of the one or more processors.

The one or more computer-readable storage media may include volatile and/or non-volatile storage constituent elements, such as optical, magnetic, organic, or other memory or disk storage devices. In some examples, the storage unit 300 may be implemented using a single physical device (e.g., one optical, magnetic, organic, or other memory or disk storage device), whereas in other examples, the storage unit 300 may be implemented using two or more physical devices.

The storage unit 300 may include computer-readable directives and additional data. The storage unit 300 may include storage necessary to perform at least part of the methods, scenarios, and technologies described in this specification and/or at least part of the functions of the devices and networks.

Further, at least a part of the storage unit 300 may be a cloud storage or a cloud server. At least a part of data corresponding to user input received from the input unit 100 and training data may be stored in the storage unit 300.

That is, the storage unit 300 is sufficient to be a space where information necessary for the operation of the kinetic typography video generation system 1000 is stored, and it may be understood that there are no constraints on physical space.

Meanwhile, the kinetic typography video generation model 400 may be configured to generate a kinetic typography video 20 from text (or text prompt 10). The kinetic typography video generation model 400 may also be referred to as the “kinetic typography diffusion model” or the “KineTy model.” The kinetic typography video generation model 400 may be configured to generate a kinetic typography video 20 corresponding to a text input. That is, the kinetic typography video generation model 400 may be configured to perform a process of generating a kinetic typography video 20 based on text.

The kinetic typography video generation model 400 may generate a kinetic typography video 20 by simultaneously considering the visual characteristics (or features, information, etc.) of the text, the movement (or motion) of the text, and the changes over time. For example, the kinetic typography video generation model 400 may generate a kinetic typography video 20 based on a text prompt input by the user. That is, the kinetic typography video generation system 1000 may provide a function that allows the user to designate details such as the external shape and movement of the text while maintaining readability of multiple characters.

This kinetic typography video generation model 400 may be trained through a kinetic typography video dataset (or training dataset) dataset built by the kinetic typography video generation system 1000. As illustrated in FIG. 2, a kinetic typography video dataset may be composed of data. The data included in the video dataset 210 may be composed of at least one of a plurality of different templates. For example, the kinetic typography video dataset 210 may include a plurality of templates (or images, videos, etc.), where each template may include a static caption describing the external shape of the text and a dynamic caption describing the movement of the text.

Conventional datasets primarily dealt with videos (or images) focusing on a single character, but the kinetic typography video dataset 210 according to the present invention deals with visual effects and animations that include several (or multiple) characters. That is, the kinetic typography video dataset 210 according to the present invention has a distinguishing feature in that it may represent animations of sentences or multiple words, rather than a single character, which differentiates it from conventional datasets. For example, the videos included in the kinetic typography video dataset 210 are composed of videos created by professional designers, and these videos visually depict how the characters move, expressed very intricately, handling complex animation effects commonly used in motion graphic design therethrough.

The kinetic typography video generation system 1000 may use kinetic typography templates and randomly replace the text content to augment the data. The augmented data may constitute a video dataset. In the present invention, the kinetic typography video generation model 400 may be trained using the data included in the augmented video dataset.

For example, the kinetic typography video generation system 1000 may generate a dataset by randomly arranging a specific number of characters from a plurality of characters, including uppercase and lowercase alphabets. This allows for a variety of arrangements and character-specific effects while maintaining consistent style between multiple characters.

In an embodiment, the videos included in the kinetic typography video dataset 210 are rendered at a preset resolution (for example, 1,920×1,080), and each video may be a video of a specific duration (for example, 3 seconds). Then, each video may be downsampled to a specific resolution (for example, 512×288) for training and converted to a specific frame rate (for example, 8 frames per second (fps)).

Further, the kinetic typography video generation system 1000 may create the rendered kinetic typography video as captions. As described above, the kinetic typography video generation system 1000 uses two types of captions, static captions and dynamic captions, in the process of building the kinetic typography video dataset 210, and may assign labels to each.

First, the typography video generation system 1000 may specify the external shape (or external appearance) of characters, including spatial information of the typography, in order to label static captions. As illustrated in FIG. 2, the static caption may describe (or depict) the color and background of the character, the glyph of the character (for example, a character with a yellow border or bold font), the characteristics of the background (for example, a textured and shiny background), and the arrangement of the characters (for example, a diagonal arrangement). This information may be created based on the information of the final frame of the video, i.e., the point in time when all characters are displayed.

Next, the typography video generation system 1000 may create dynamic captions by focusing on the temporal changes of motion in each frame of the videos. The dynamic captions may be configured to describe the movement aspects of the video, such as whether each character appears sequentially or randomly, whether it rotates, or whether there is a fade-in effect.

In an embodiment, the typography video generation system 1000 may use a generative AI model (for example, the GPT-4 Vision model) in the process of generating dynamic captions to assign labels to the video for a more systematic process, and then may correct any missing or incorrectly labeled parts through review and modification.

Further, the typography video generation system 1000 may generate a kinetic typography video corresponding to the ground truth (for example, Ground-truth Video). For example, during training, randomly generated composite words are used, but in the final evaluation stage, actual words are used. That is, realistic words are necessary to evaluate the matching between the text and the video, so actual words are used. This allows for confirming whether the kinetic typography video generation model 400 generates a video corresponding to the user input.

In this way, the captions assigned (or included) to each video may be configured to describe the visual elements of each video (for example, the color, font, size, etc. of the character) and animation effects (e.g., actions such as how characters move, rotate, or fade). This allows the kinetic typography video generation model 400 to learn the captions, better understand the visual external appearance and movement of the text, and play a crucial role in generating new kinetic typography videos.

That is, the kinetic typography video generation model 400 is trained using the kinetic typography video dataset 210 as training data, and the trained kinetic typography video generation model 400 may generate a kinetic typography video 20 through a diffusion process. In this case, the kinetic typography video generation model 400 may generate a kinetic typography video 20 in the diffusion process, conditioning on the static caption and dynamic caption, in a manner that respectively affects the spatial characteristics (for example, position, size, etc.) and temporal characteristics (for example, movement) of the text. Additionally, the kinetic typography video generation model 400 may significantly improve the clarity and readability of the text through zero convolution. This may be an important process performed to ensure that the text is clearly visible even against complex backgrounds or within movements.

Meanwhile, the present invention is directed to providing a kinetic typography video generation system capable of automatically generating kinetic typography videos, a control method thereof, and a learning method of the kinetic typography video generation system. More specifically, the present invention is directed to providing a kinetic typography video generation model capable of generating kinetic typography videos based on a text prompt input by the user, and hereinafter, the learning method of the kinetic typography video generation model 400 will be described in more detail.

First, in the present invention, a typography video to be trained is input to an encoder (S310), and from the encoder, a latent vector for the video is acquired (S320, see FIG. 3).

Meanwhile, as described above, the kinetic typography video generation model 400 may be a diffusion model that generates kinetic typography videos through the diffusion process.

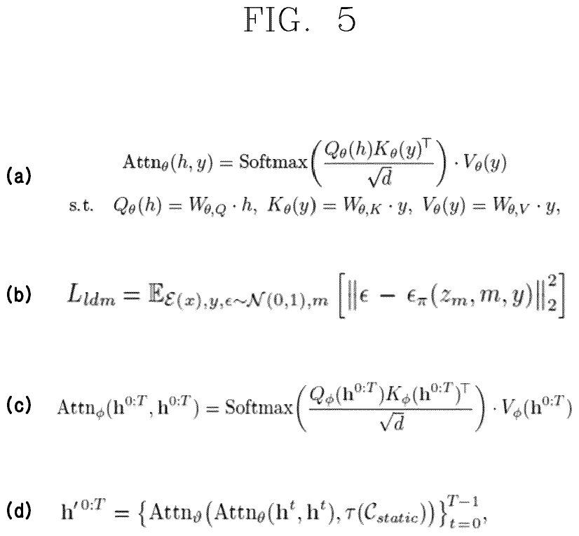

In this regard, an image diffusion model (or diffusion model, conditional latent diffusion model) gradually refines an initial state (zM˜N(0,1)) with noise present into a target data representation (z0) during M diffusion steps, learning the data distribution. More specifically, the image diffusion model receives an image as input, encodes it into a latent vector (or representation, Z₀=ε(x)), and performs a process of converting it back into an image using the decoder (D(z0)). For example, in the above process, the operation of adding and removing noise may be performed through a noise removal network (∈_{□}) based on U-Net. U-Net may be understood as a network structure advantageous for processing both detailed information of the image and the overall structure through multiple layers. In addition, the condition (y) may be mapped to a hidden state (h) through an attention mechanism. The image diffusion model receives a specific condition as input and generates an image based on the corresponding condition. This condition may be delivered to the hidden state of the image diffusion model through the attention mechanism and may be used to generate an image having a specific style or a specific shape. This may be expressed by the equation illustrated in FIG. 5A.

In the equation illustrated in FIG. 5A, W_{θ,Q}, W_{θ,K}, and W_{θ,v} may respectively represent learnable parameters for queries, keys, and values. Queries, keys, and values refer to learnable weights for the three elements, and the image diffusion model learns the weights while processing data. In addition, d may represent the number of dimensions of the keys. The number of dimensions of the keys is an important element that represents features of the input data, and for example, in data such as text or images, the dimensional value is set to extract specific patterns or features.

Here, the objective function of the noise removal network may be expressed as the equation illustrated in FIG. 5B. ∥·∥2 refers to the L2 distance and is a method of calculating the straight-line distance between two points. Mathematically, it is calculated by squaring the difference between two vectors, summing the result, and then taking the square root of that value. The L2 loss function is often used to reduce the difference between the value predicted by the model and the actual value. In addition, the diffusion step (m∈{1, . . . , M}) may be uniformly sampled during the training process. In the image diffusion model, noise is added to the data over multiple steps, and the model learns the process of restoring it. Here, m refers to one of such diffusion steps, and in the training process, the corresponding step may be uniformly sampled. That is, in order to allow the image diffusion model to learn the ability to restore data at various steps, m may be selected with a uniform probability.

This objective function of the noise removal network is used to optimize the image diffusion model so as to start from a noisy state and gradually refine and restore the data. That is, the objective function plays an important role in evaluating the performance of the model and extracting optimal parameters during the training process.

Meanwhile, in the present invention, the functionality of the image diffusion model described above has been extended to video generation. By introducing temporal self-attention, called motion modules (or layers, blocks, etc.), the typography video generation model 400 learns temporal consistency between frames T in the latent sequence

$$( {z}_{0}^{0 : T} ) .$$

The motion module is an important component for learning the temporal relationship between video frames, and this may make the changes over time smooth by considering the connectivity between frames. Through this, the typography video generation model 400 learns to make each frame transition naturally according to the flow of time.

In addition, the above latent sequence may correspond to the video sequence

$$( {\tilde{X}}^{0 : T} = D ( {z}_{0}^{0 : T} ) ) .$$

Here, the latent sequence is a latent vector (compressed representation) of the video frames, and this may be restored back into a video sequence through the decoder. That is, each frame is restored based on the information learned from the latent sequence, and temporal consistency may be maintained. Through this, the typography video generation model 400 may generate continuous images that change smoothly over time, and the temporal self-attention described above may be expressed by the equation illustrated in FIG. 5C.

Meanwhile, as illustrated in FIG. 4, the typography video generation system 1000 may input a typography video to be trained 401 into an encoder 410 of the kinetic typography video generation model 400.

Here, the typography video to be trained 401 may be a video including various visual effects (for example, character shape, color, background, etc.). More specifically, the target video to be trained 401 may include spatial information (or spatial characteristics) of the text included in the video and temporal information (or temporal characteristics) about the movement of the text changing over time, which are existed therein. For example, the spatial information may be fixed visual information such as the color or shape of the text itself and the background, and the temporal information may include the order in which characters appear and move, or changes in arrangement over time.

The encoder 410 of the kinetic typography video generation model 400 may process the input video 401 and generate a latent vector 402. The encoder 410 may encode the spatial and temporal characteristics of the video 401 and convert them into a latent vector (or latent representation) 402. The latent vector 402 may be a compressed representation including both spatial information and temporal information of the video 401. That is, the encoder 410 may extract static and dynamic characteristics of the text included in the video 401 and convert them into a latent vector 402 including noise. This latent vector 402 may be gradually reconstructed into a form close to the original data through multiple diffusion steps.

Further, in the present invention, a process of inputting the latent vector into temporal-spatial processing blocks that process spatial information and temporal information may be performed (S330, see FIG. 3).

The kinetic typography video generation model 400 (or, the kinetic typography video generation system 1000) may process the latent vector 402 acquired from the encoder as input to the temporal-spatial processing block 420 that processes spatial information and temporal information. In the present invention, the term “block” may also be referred to as a “layer” or “module.”

As illustrated in FIG. 4, the temporal-spatial processing block 420 may include a spatial block (or spatial attention block) for processing spatial information and a temporal block (or temporal attention block) for processing temporal information. Each block included in the temporal-spatial processing block 420 may sequentially process information, and may learn more complex patterns in the processing stage. The temporal-spatial processing block 420 operates in a diffusion manner that gradually removes noise or emphasizes specific patterns through such a hierarchical structure, and the result processed by each block is delivered to the next block, and the information may be gradually refined. The structure of the temporal-spatial processing block 420 may combine spatial and temporal information and may learn the movement of text and visual characteristics simultaneously. That is, the temporal-spatial processing block 420 may be understood as having a hierarchical structure that gradually converts input data while simultaneously processing spatial information and temporal information.

In this regard, in the kinetic typography video generation model 400, the spatial blocks 421a, 421b, 421c, 421d, and 421e and the temporal blocks 422a, 422b, 422c, 422d, and 422e may exist as pairs. For example, the first spatial block 421a and the first temporal block 422a may form a pair, and the fifth spatial block 421e and the fifth temporal block 422e may also form a pair.

In this case, as the kinetic typography video generation model 400 is configured in a hierarchical structure, the spatial blocks 421a, 421b, 421c, 421d, and 421e may include spatial downsampling blocks and spatial upsampling blocks, and the temporal blocks 422a, 422b, 422c, 422d, and 422e may include temporal downsampling blocks and temporal upsampling blocks.

In an embodiment, among the spatial blocks 421a, 421b, 421c, 421d, and 421e, the second spatial block 421b and the third spatial block 421c may correspond to temporal downsampling blocks, and the fourth spatial block 421d and the fifth spatial block 421e may correspond to temporal upsampling blocks.

In another embodiment, among the temporal blocks 422a, 422b, 422c, 422d, and 422e, the second temporal block 422b and the third temporal block 422c may correspond to temporal downsampling blocks, and the fourth temporal block 422d and the fifth temporal block 422e may correspond to temporal upsampling blocks.

Accordingly, in the temporal-spatial processing block 420 of the encoder 410, the spatial downsampling block and the temporal downsampling block may exist as a pair, and the spatial upsampling block and the temporal upsampling block may exist as a pair. For example, the second spatial block 421b and the second temporal block 422b, which correspond to the downsampling block, may exist as a pair, and the fourth spatial block 421d and the fourth temporal block 422d, which correspond to the upsampling block, may exist as a pair.

Further, the latent vector 402 may be input to paired blocks. For example, the kinetic typography video generation model 400 may process the latent vector 402 as input to the first spatial block 421a and the first temporal block 422a, which form a pair.

Meanwhile, in the present invention, static captions and dynamic captions for the text included in the video are injected into the temporal-spatial processing blocks (S340), and a process of acquiring a latent vector reflecting spatial information and a latent vector reflecting temporal information from the temporal-spatial processing blocks may be performed (S350, see FIG. 3).

Although the overall features of the input video 401 in the encoder are compressed and represented as a latent vector, the information obtained thereby may be abstract. Accordingly, in the present invention, by using the static caption 401a, the dynamic caption 401b, and the word caption 401c together in the training process of the kinetic typography video generation model 400, the kinetic typography video generation model 400 may learn (or be provided with) more specific element-wise feedback, not only learning the compressed representation of the video 401. In the present invention, the kinetic typography video generation model 400 may separately learn the static characteristics and the dynamic movements of the text and background included in the video 401 as the static caption 401a and the dynamic caption 401b, respectively.

Here, the static caption 401a may include a description of at least one of the visual external appearance of the text (for example, the color and background of the text, the glyph of the text, the characteristics of the background, the arrangement of the text, etc.) or the characteristics of the background included in the video 401. In addition, the dynamic caption 401b may include a description of at least one of a motion (or movement), an appearance order, or a change pattern of the text according to the temporal change of the video 401.

The kinetic typography video generation system 1000 may process the static caption 401a and the dynamic caption 401b as input to each of the spatial blocks 421a, 421b, 421c, 421d, and 421e and the temporal blocks 422a, 422b, 422c, 422d, and 422e included in the temporal-spatial processing block 420.

First, the kinetic typography video generation system 1000 may inject the static caption describing the spatial information of the text into the spatial blocks 421a, 421b, 421c, 421d, and 421e of the encoder 410. The spatial blocks 421a, 421b, 421c, 421d, and 421e may be configured to learn only static features that are unrelated to time, such as spatial information of the text included in the video 401 (for example, the shape, color, background, size of the text, etc.). That is, the spatial blocks 421a, 421b, 421c, 421d, and 421e may be configured to perform the role of processing the fixed characteristics of the text.

The fact that the static caption 401a is input to the spatial blocks 421a, 421b, 421c, 421d, and 421e may be understood as being for clearly learning fixed visual characteristics such as the shape, color, and background of the text included in the video 401. When the latent vector 402 extracted from the video 401 is the compressed representation of the overall information of the video 401, the static caption 401a may provide feedback on spatial features. For example, when the kinetic typography video generation model 400 has not properly learned the shape or color of the text, it may receive feedback through the static caption, allowing for more accurate adjustment during training by learning the shape or color of the character.

That is, since the kinetic typography video generation model 400 may have difficulty in expressing the fine external shape characteristics of each text merely by understanding the overall context of the video 401, the static caption 401a may play a role in clearly specifying how the text should appear in a specific frame of the video 401, and may be used as data for enabling the kinetic typography video generation model 400 to accurately reproduce the external appearance of the text and background in each frame of the video 401.

The kinetic typography video generation system 1000 may express (or define) the static caption 401a and the spatial blocks 421a, 421b, 421c, 421d, and 421e to which cross-attention is applied after self-attention, with the equation illustrated in FIG. 5D, by using the equation illustrated in FIG. 5A.

Here, in the equation illustrated in FIG. 5D, τ(·) may represent the encoder 410. This encoder 410 may also be understood as a “CLIP text encoder,” and may be used to learn text and image together to understand the association between the two. The encoder 410 may convert the input text into a vector representation, and may use this for image generation or recognition. For example, when text is input, the encoder 410 may generate a latent vector corresponding to the text, and such a vector may be used (or utilized) when the model 400 learns the association between images and text. The encoder 410 may convert the static caption 401a or the dynamic caption 401b into a vector, and may play an important role in enabling the model 400 to learn the relationship between the text and the video based thereon.

Meanwhile, the spatial blocks 421a, 421b, 421c, 421d, and 421e may output a latent vector in which spatial information is reflected, through a preset spatial diffusion mechanism. The spatial diffusion mechanism may include spatial self-attention, spatial cross-attention, zero convolution, and element-wise addition processes.

Hereinafter, the spatial diffusion mechanism will be briefly described.

In the spatial diffusion mechanism process, the data (h) input to the spatial block may be data converted into a latent form from video data used for training (or inference)

First, in the spatial self-attention process, the spatial block may calculate (or extract) attention between video frames through spatial self-attention of the input data (h), and may maintain unity of the varying parts according to time (or space). Then, the spatial block may perform conditioning of the static caption 401a and the word caption 401c respectively through spatial cross-attention on the data (h) output through spatial self-attention.

Here, the data output by conditioning the word caption 401c, due to the use of zero convolution, may prevent adding random noise to the existing text conditioning model, thereby allowing the model 400 to be optimized.

Furthermore, the spatial block may perform element-wise addition on a first value output by performing spatial cross-attention on the data (h) output through spatial self-attention and the static caption 401a, and a second value output by performing zero convolution on the value obtained by performing spatial cross-attention between the data (h) and the word caption 401c.

Next, the kinetic typography video generation system 1000 may inject the dynamic caption 401b, which describes the temporal information of the text, into the temporal blocks 422a, 422b, 422c, 422d, and 422e. The temporal blocks 422a, 422b, 422c, 422d, and 422e may be configured to learn temporal information of the text included in the video 401 (for example, movement and change of characters, etc.). For example, the temporal blocks 422a, 422b, 422c, 422d, and 422e may learn how the text appears on the screen, and how the shape or arrangement of the text changes over time. That is, the temporal blocks 422a, 422b, 422c, 422d, and 422e may be configured to process dynamic changes of the text.

The fact that the dynamic caption 401b is input to the temporal blocks 422a, 422b, 422c, 422d, and 422e may be understood as being for clearly learning the movement of the text that changes over time in the video 401. For example, although the encoder 410 extracts the temporal characteristics of the video 401, without specific feedback, such information may not be sufficiently learned. Accordingly, through the dynamic caption 401b, each block may more clearly receive feedback on the movement or order of the text according to temporal changes, and the kinetic typography video generation model 400 may learn the dynamic characteristics of the text (for example, motion, appearance order, change patterns, etc.) in each frame based on the dynamic caption 401b, thereby not only achieving temporal consistency but also accurately expressing text-specific motion effects suitable for the input text.

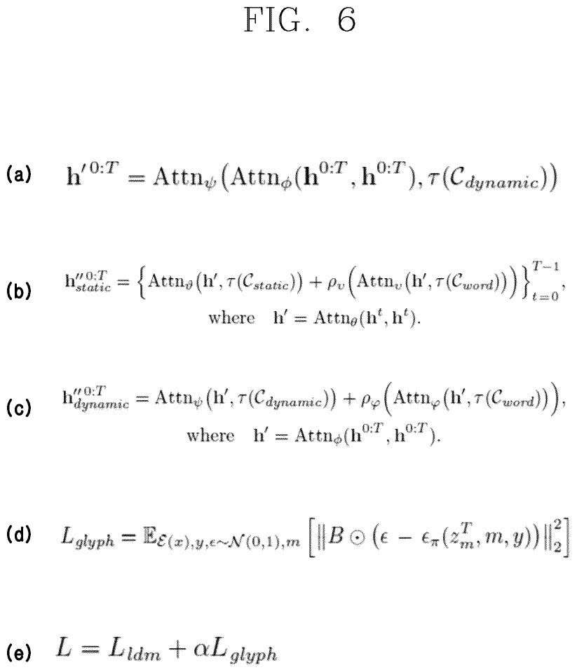

In kinetic typography videos, since it is important to accurately display the dynamic motion effects of each character in the video according to the textual description, in the present invention, the dynamic caption 401b is added, and the equation illustrated in FIG. 5C may be extended and expressed as the equation illustrated in FIG. 6A.

Meanwhile, the temporal blocks 422a, 422b, 422c, 422d, and 422e may output a latent vector in which temporal information is reflected, through a preset temporal diffusion mechanism. The temporal diffusion mechanism may include temporal self-attention, temporal cross-attention, zero convolution, and element-wise addition processes.

Hereinafter, the temporal diffusion mechanism will be briefly described.

In the temporal diffusion mechanism process, the data (h) input to the temporal block may be data converted into a latent form from video data used for training (or inference).

First, in the temporal diffusion mechanism process, the temporal block may calculate (or extract) attention between video frames through temporal self-attention of the input data (h), and may maintain unity of the parts that change over time. Then, the temporal block may perform conditioning of the dynamic caption 401b and the word caption 401c respectively through temporal cross-attention on the data (h) output through temporal self-attention.

Here, the data output by conditioning the word caption 401c, due to the use of zero convolution, may prevent adding random noise to the existing text conditioning model, thereby allowing the model 400 to be optimized.

Further, the temporal block may perform element-wise addition on a first value output by performing spatial cross-attention on the data (h′) output through spatial self-attention and the dynamic caption 401b, and a second value output by performing zero convolution on the value obtained by performing temporal cross-attention between the data (h′) and the word caption 401c.

Meanwhile, in the present invention, the word caption 401c for the text included in the video 401 may be injected into the temporal-spatial processing block 420. The word caption 401c may be configured to describe the overall structure and meaning of the text. More specifically, the word caption 401c may be information of the entire sentence or word, and may represent a structure of the sentence and a manner in which the characters are arranged.

The kinetic typography video generation model 400 needs to learn how each text included in the video 401 is arranged and connected in the overall context of the text, rather than generating each text separately. That is, it is necessary to learn the relationships between texts. When the encoder 410 merely learns features of individual texts, the word caption 401c may provide feedback for learning a manner in which characters are connected into a single word. This may play an important role in verifying whether the sentence or word is properly constructed and in maintaining consistency between characters.

The kinetic typography video generation system 1000 may specify at least one block among the blocks included in the temporal-spatial processing block 420 into which the word caption 401c is to be injected. As described above, the spatial blocks 421a, 421b, 421c, 421d, and 421e may include spatial downsampling blocks and spatial upsampling blocks, and the temporal blocks 422a, 422b, 422c, 422d, and 422e may include temporal downsampling blocks and temporal upsampling blocks.

First, the pair of the first spatial block 421a and the first temporal block 422a among the blocks included in the temporal-spatial processing block 420 may extract richer information without compressing the input video (or data, latent vector, etc.). The pair of the first spatial block 421a and the first temporal block 422a may extensively learn the overall static and dynamic characteristics of the video 401.

Next, in the downsampling block section, the data may be compressed and important features may be extracted. More specifically, the downsampling block section is a process of encoding the input video 401 into a low-dimensional latent space, in which a process of compressing the resolution or dimension of the video 401 while extracting important features may be performed. For example, among the blocks included in the temporal-spatial processing block 420, the pair of the second spatial block 421b and the second temporal block 422b, and the pair of the third spatial block 421c and the third temporal block 422c, which correspond to the downsampling blocks, may compress spatial and temporal information into small and important information and convert high-dimensional visual data into a latent space (for example, by reducing high-resolution frames of the video to extract only meaningful key features).

Further, in the upsampling block section, the data may be expanded and the compressed information may be restored again. More specifically, the upsampling block section is a process of expanding the input video 401 to its original resolution or dimension, in which a process of restoring the encoded data again may be performed. For example, among the blocks included in the temporal-spatial processing block 420, the pair of the fourth spatial block 421d and the fourth temporal block 422d, and the pair of the fifth spatial block 421e and the fifth temporal block 422e, which correspond to the upsampling blocks, may be blocks performing a process of restoring to its original resolution or shape based on compressed information, and by restoring the spatial and temporal information again based on the compressed latent vector, may ultimately extract the static and dynamic characteristics of the typography.

That is, the process performed in the downsampling blocks may be related to noise. This is because, by compressing the data to retain important patterns and expanding it again in the upsampling block section based thereon, the downsampling blocks and the upsampling blocks may interact with each other to filter out unnecessary information and perform a process of restoring only important features.

Accordingly, the kinetic typography video generation system 1000 may specify the upsampling blocks as blocks into which the word caption 401c is to be input. Then, the kinetic typography video generation system 1000 may process the input of the word caption 401c into the specified upsampling blocks. For example, the kinetic typography video generation system 1000 may specify the pair of the fourth spatial block 421d and the fourth temporal block 422d, and the pair of the fifth spatial block 421e and the fifth temporal block 422e, as blocks into which the word caption 401c is to be input, and may input the word caption 401c into the specified pairs. In this case, the blocks into which the word caption 401c is input may be understood as blocks in which spatial and temporal cross-attention is performed.

Meanwhile, the kinetic typography video generation system 1000 may weight the spatial block between the word caption 401c and the hidden feature using zero convolution, and may extend the equation illustrated in FIG. 5D. The extended equation may be expressed as the equation illustrated in FIG. 6B.

In addition, the kinetic typography video generation system 1000 may integrate the word caption 401c into the temporal blocks 422a, 422b, 422c, 422d, and 422e in the same manner. Accordingly, the equation illustrated in FIG. 6A may be finalized and expressed as the equation illustrated in FIG. 6C.

Meanwhile, in the present invention, a process of inputting the latent vector reflecting spatial information and the latent vector reflecting temporal information into the decoder (S360), and acquiring the final typography video corresponding to the input from the decoder (S370, see FIG. 3), may be performed.

Further, in the present invention, a process of training the kinetic typography video generation model using the final typography video and the typography video to be trained may be performed (S380, see FIG. 3).

The decoder 430 of the kinetic typography video generation model 400 may reconstruct the typography of the video 401 based on the information extracted from the encoder 410. More specifically, the decoder 430 may receive as input the latent vector reflecting spatial information and the latent vector reflecting temporal information and may generate a reconstructed kinetic typography video 431. That is, the decoder 430 may generate a video 431 similar to the input video 401 based on the learned information, and here, the decoder 430 may learn how the static caption 401a, the dynamic caption 401b, and the word caption 401c each act.

The decoder 430 may generate the final kinetic typography video 431 by combining the latent vector reflecting spatial information and the latent vector reflecting temporal information. Then, the kinetic typography video generation system 1000 may acquire the final kinetic typography video 431 output from the decoder 430 and may train the kinetic typography video generation model 400 using the acquired final typography video 431.

The kinetic typography video generation system 1000 may define a loss function for training the kinetic typography video generation model 400. The kinetic typography video generation system 1000 may define a loss function using L_{□□□}, and additionally, in order to train the kinetic typography video generation model 400 to more accurately express the clear and correct glyphs (i.e., text shapes) of text content in the text region, may impose an additional penalty on the text region.

First, in the present invention, a binary mask (B) is used in the last frame (V^{□}) of the video to indicate precisely where the text is located. The corresponding mask may be blurred in order to include visual effects existing around the text. Subsequently, pixel-wise weights may be applied using the blurred mask. That is, rather than simply emphasizing the boundary of the text, it also considers the surrounding motion effects, and such a weight may allow the model to express the text more accurately. The loss reflecting this (e.g., glyph loss) may be represented by the equation illustrated in FIG. 6D.

In the equation illustrated in FIG. 6D, ⊙ may represent element-wise addition. Through the glyph loss, the readability of text content may be improved, allowing multiple characters to be accurately placed. The final loss function may be expressed as the equation illustrated in FIG. 6E through a linear combination of the two loss terms.

As a result, the glyph loss serves as an important element for maintaining clarity and accuracy of text, enabling the model 400 to express text content more accurately, and optimizing overall quality while maintaining visual correctness of text. In the present invention, the above-described loss function may also be referred to as a preset loss function.

Further, using the preset loss function, the kinetic typography video generation model 400 may be trained by calculating the loss between the typography video to be trained 401, corresponding to the ground truth data, and the final typography video 431 generated by the decoder 430, and minimizing the loss.

The kinetic typography video generation model 400 according to the present invention, as described above, may be trained in two stages. First, the kinetic typography video generation model 400 may learn a spatial external appearance (i.e., a static image). In this learning stage, only the static caption and the last frame of the video are used so that the model 400 may learn the shape of the characters (text) and the background. In this case, since temporal attention is not used, the model may operate like a text-to-image diffusion model. In the next stage, the entire model is used to learn the entire video frames and captions. In this case, while the spatial attention remains fixed, mainly the temporal attention may be trained.

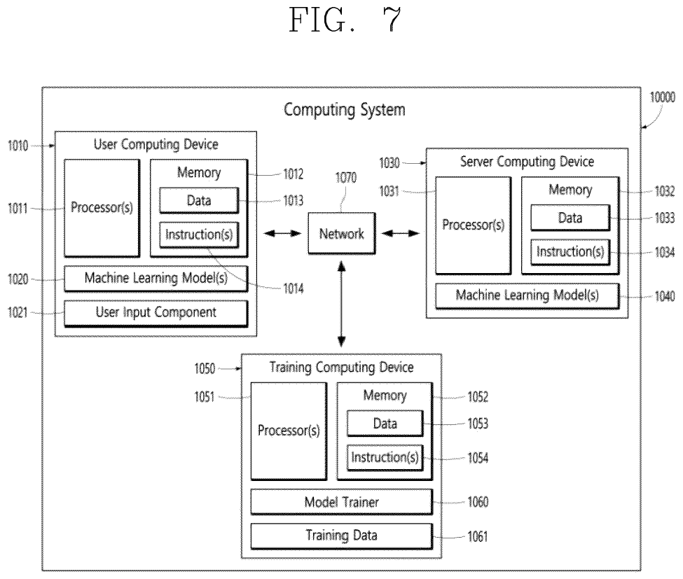

Meanwhile, FIG. 7 illustrates an example block diagram of a computing system in which the present invention may be implemented.

Referring to FIG. 7, a computing system (10000) for performing a control method of a kinetic typography video generation system and a training method of the kinetic typography video generation system according to an embodiment of the present invention may include at least one computing device. In this case, the at least one computing device may be a single-processor or multi-processor computing apparatus.

The components of the at least one computing device of the present invention may include one or more processors, memory, other hardware, and various system components connected (e.g., communicatively, physically, or electrically connected) via a system bus (not shown) that enables data to be transmitted and received among them. The components of the at least one computing device are not limited thereto and may vary widely.

Meanwhile, the at least one computing device included in the computing system (10000) that performs a control method of a kinetic typography video generation system and a training method of the kinetic typography video generation system may be communicatively connected via a network (1070). For example, the at least one computing device included in the computing system (10000) may be clustered or may be part of a local area network (LAN). Additionally, the at least one computing device may be part of a wide area network (WAN) or connected via at least one of a client-server network or a peer-to-peer network in a cloud environment.

Meanwhile, when the at least one computing device is used in at least one environment among a network environment and a cloud computing environment, the at least one computing device may be connected to at least one of a public network and a private network through a network interface or adapter. In one embodiment, other communication connection devices, such as a modem, may be used to establish communication over the network. The modem may be at least one of an internal modem and an external modem, and may be connected to the system bus through a network interface or a specific mechanism. A wireless network component comprising an interface and an antenna may be coupled to the network through devices such as access points or peer computers. In the present invention, the method by which the at least one computing device is communicatively connected via the network (1070) is not limited thereto and may be implemented by means other than the examples described above.

Furthermore, other computer-type devices and/or systems not illustrated in FIG. 7 may technically interact with the at least one computing device or other systems through one or more connections to the network (1070) via a network interface. Here, the network interface may include network interface equipment such as a physical Network Interface Controller (NIC) or a Virtual Interface (VIF).

The network (1070) of the present invention may include various types of networks such as the Internet, Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), High Speed Uplink Packet Access (HSUPA), Long Term Evolution (LTE), Long Term Evolution-Advanced (LTE-A), 5th Generation Mobile Telecommunication (5G), Bluetooth™, Radio Frequency Identification (RFID), Infrared Data Association (IrDA), Ultra-Wideband (UWB), ZigBee, Near Field Communication (NFC), Wireless Universal Serial Bus (Wireless USB), and the like. In the present invention, data transmission may be performed based on standard communication protocols such as TCP/IP, HTTP, SSL, and others.

The computing system (10000) for performing a control method of a kinetic typography video generation system and a training method of the kinetic typography video generation system according to the present invention may include at least one of a user computing device (1010), a training computing device (1050), and a server computing device (1030).

The user computing device (1010) according to the present invention may be understood as a computing device including at least one processor (1011) and memory (1012) for performing a control method of a kinetic typography video generation system and a training method of the kinetic typography video generation system. For example, the user computing device (1010) may include at least one computing device selected from among a smart phone, smart TV, laptop computer, desktop computer, digital broadcasting terminal, personal digital assistant (PDA), portable multimedia player (PMP), navigation device, slate PC, tablet PC, ultrabook, and wearable device (e.g., smartwatch, smart glass, and head-mounted display (HMD)).

The at least one processor (1011) constituting the user computing device (1010) may include one or more general-purpose processors and/or one or more special-purpose processors. For example, the at least one processor (1011) of the user computing device (1010) may include at least one or a combination of electrically connected processors selected from the group consisting of: a Central Processing Unit (CPU), a Graphics Processing Unit (GPU), a Tensor Processing Unit (TPU), a Neural Processing Unit (NPU), an Arithmetic Logic Unit (ALU), a Floating Point Unit (FPU), an Application-Specific Integrated Circuit (ASIC), a digital signal processing device (D SPD), a programmable logic device (PLD), a Field Programmable Gate Array (FPGA), a controller, a microcontroller, a microprocessor, and other electrical units for performing specific functions.

Furthermore, the at least one processor (1011) may be configured to execute computer-readable instructions stored in the memory (1012) and/or other commands described in the present specification.

The memory (1012) constituting the user computing device (1010) according to the present invention may include volatile memory, non-volatile memory, fixed media, removable media, magnetic media, optical media, semiconductor media, and/or other types of physically durable storage media.

For example, the memory (1012) may include one or more non-transitory/transitory computer-readable storage media, or combinations thereof, such as Random Access Memory (RAM), Read Only Memory (ROM), Hard Disk Drive (HDD), Solid State Disk (SSD), Silicon Disk Drive (SDD), Electrically Erasable Programmable Read-Only Memory (EEPROM), Erasable Programmable Read-Only Memory (EPROM), flash memory devices, and magnetic disks. It may also include web storage of a server that performs the memory storage function over the Internet.

The memory (1012) may store data and instructions necessary for the at least one processor (1011) to perform operations of an application for controlling the kinetic typography video generation system and training the kinetic typography video generation system.

The user computing device (1010) may include one or more user input components (1021) configured to detect user input. For example, the user input component (1021) may also be referred to as a user interface module. The user input component (1021) may include devices such as a touchscreen, computer mouse, keyboard, keypad, touchpad, trackball, joystick, voice recognition module, or other similar devices. However, the present invention does not limit the types of the user input component (1021).

In this context, the user input component (1021) in the present invention is not necessarily limited to a hardware means but may be understood as a channel through which input is received from a user.

Meanwhile, the “user” in the present invention may also refer to an automated agent, script, playback software, or the like that operates on behalf of one or more human users.

A user may interact with the computing system (10000), which includes at least one computing device, through the user input component (1021) using inputted text, touch, voice, motion, computer vision, gesture, and/or other forms of input/output. For example, the user input component (1021) may include one or more user interface (UI) modalities such as a Command Line Interface (CLI), Graphical User Interface (GUI), Natural User Interface (NUI), voice command interface, and/or other UI representations.

One or more Application Programming Interface (API) calls may be made between the user input component (1021) and the user computing device (1010), based on user input received through a user interface and/or from a network.

Herein, the phrase “based on” may be interpreted to include instances where a particular configuration is used as a foundation, modified from, derived from, influenced by, dependent on, or otherwise originating from such configuration.

In some embodiments, the API call may be configured for a specific API and may be interpreted as, or converted into, an API call configured for a different API. In this context, the API may refer to a defined interface or connection between computers or between computer programs.

In one embodiment, the user computing device (1010) may store one or more machine learning models (1020). For example, the user computing device (1010) may include various machine learning models such as multiple neural networks (e.g., deep neural networks) that perform control method of a kinetic typography video generation system and a training method of the kinetic typography video generation system. These machine learning models may also include other types of models such as nonlinear models and/or linear models or may be a combination thereof.

According to an embodiment of the present invention, the user computing device (1010) may perform a control method and a training method of a kinetic typography video generation system by using a local and/or external machine learning model (1020). Alternatively, the user computing device (1010) may perform the control method and the training method of the kinetic typography video generation system by using a machine learning model (1040) provided by a server.

For example, the user computing device (1010) may perform the control method and the training method of the kinetic typography video generation system by using a typography generation model.

According to another embodiment of the present invention, a server computing device (1030) communicating with the user computing device (1010) may generate a kinetic typography video in response to a user request received via the user computing device (1010) and provide the generated video to the user computing device (1010) via an application and/or a web interface.

According to yet another embodiment of the present invention, at least a portion of the user computing device (1010) and the server computing device (1030) may be cooperatively operated to perform a control method and a training method of the kinetic typography video generation system, thereby providing a kinetic typography video to the user.

According to various embodiments of the present invention, the user computing device (1010) and/or the server computing device (1030) may train the machine learning models (1020, 1040) used in control method of a kinetic typography video generation system and a training method of the kinetic typography video generation system through interaction with a training computing device (1050) that is communicatively connected via the network (1070). For example, the user computing device (1010) and/or the server computing device (1030) may train a kinetic typography video generation model through interaction with a training computing device (1050) that is communicatively connected via a network (1070).

In this case, the training computing device (1050) may be a computing system separate from the server computing device (1030). Alternatively, in some embodiments, the training computing device (1050) may be a part of the server computing device (1030) or a part of the user computing device (1010).

Meanwhile, the server computing device (1030) may include at least one processor (1031) and memory (1032). Here, the processor (1031) may include at least one or a combination of electrically connected processors selected from among: a Central Processing Unit (CPU), Graphics Processing Unit (GPU), Tensor Processing Unit (TPU), Neural Processing Unit (NPU), Application-Specific Integrated Circuit (ASIC), Arithmetic Logic Unit (ALU), Floating Point Unit (FPU), digital signal processing devices (DSPDs), programmable logic devices (PLDs), Field Programmable Gate Arrays (FPGAs), controllers, microcontrollers, microprocessors, and/or other electrical units for performing specific functions. For example, the at least one processor (1031) may include circuits and transistors configured to execute instructions from the memory (1032).

The memory (1032) constituting the server computing device (1030) according to the present invention may include volatile memory, non-volatile memory, fixed media, removable media, magnetic media, optical media, semiconductor media, and/or other types of physically durable storage media.

For example, the memory (1032) may include one or more transitory/non-transitory computer-readable storage media, or combinations thereof, such as Random Access Memory (RAM), Read Only Memory (ROM), Hard Disk Drive (HDD), Solid State Disk (SSD), Silicon Disk Drive (SDD), Electrically Erasable Programmable Read-Only Memory (EEPROM), Erasable Programmable Read-Only Memory (EPROM), flash memory devices, and magnetic disks. It may also include web storage of a server that performs memory storage functions over the Internet.

Additionally, the server computing device (1030) may further include a data store. For example, the data store may be configured as at least one of a relational database, a NoSQL database, a data warehouse, and a local file system.

The memory (1032) constituting the server computing device (1030) according to the present invention may store data and instructions necessary for the at least one processor (1031) to perform operations of an application for controlling the kinetic typography video generation system and training the kinetic typography video generation system.

In one embodiment, the server computing device (1030) may be configured as a single device or as a plurality of computing devices, which may be configured to operate according to a sequential or parallel computing architecture. Additionally, the system may be implemented as a distributed processing system comprising multiple devices connected over a network.

Meanwhile, the training computing device (1050) may include at least one processor (1051) and memory (1052). A model trainer (1060), as a logical component that performs training of at least one machine learning model (1020, 1040), may be implemented in the form of hardware, firmware, or software.

For example, the model trainer (1060) may load training data (1061) stored in a storage device into the memory (1052), and then be executed by the processor (1051). The model trainer (1060) may be configured to perform one or more operations-such as model training, model reconstruction, model validation, and model testing-on at least one machine learning model.

The machine learning model according to the present invention may include at least one of the following: a statistical model, an algorithm, a neural network (NN), a convolutional neural network (CNN), a generative neural network (GNN), a Word2Vec model, a Bag of Words model, a Term Frequency-Inverse Document Frequency (TF-IDF) model, a Generative Pre-trained Transformer (GPT) model (or other autoregressive models), a Proximal Policy Optimization (PPO) model, a nearest neighbor model (e.g., k-nearest neighbor model), a linear regression model, a k-means clustering model, a Q-learning model, a Temporal Difference (TD) model, a Deep Adversarial Network model, and any other type of model described in the present specification.

Specifically, the model trainer (1060) may perform operations for training a machine learning model, and the operations may include at least one of adding, removing, and modifying model parameters. In this case, the training of the machine learning model may be at least one of supervised learning, semi-supervised learning, and unsupervised learning.

In one embodiment, training of the machine learning model may include a step of repeatedly inputting the training data (1061) based on epochs, and iteratively performing the machine learning model training process configured in this manner. Here, an epoch may refer to a unit representing one complete forward and backward pass of the entire training data (1061) set.

In some implementations, different learning methods (e.g., supervised learning, semi-supervised learning, and unsupervised learning) may be applied at different epochs.

The training data (1061) of the present invention may include input data and/or data previously output from at least one machine learning model (e.g., recursive learning feedback).

The parameters of the at least one machine learning model may include at least one of a seed value, model nodes, model layers, algorithms, functions, connections between different machine learning models, connections between parameters, constraints of the machine learning model, and other digital components that influence the output of the machine learning model.

In this case, a model connection between different machine learning models may include or represent relationships between model parameters and/or between models, which may be dependent, interdependent, hierarchical, and/or static or dynamic.

The combination and configuration of the model parameters described herein may be too complex to be maintained or utilized by human cognitive capabilities.

The present invention does not limit the parameters of machine learning models to those described in the embodiments, and a single machine learning model may include a plurality of model parameters.

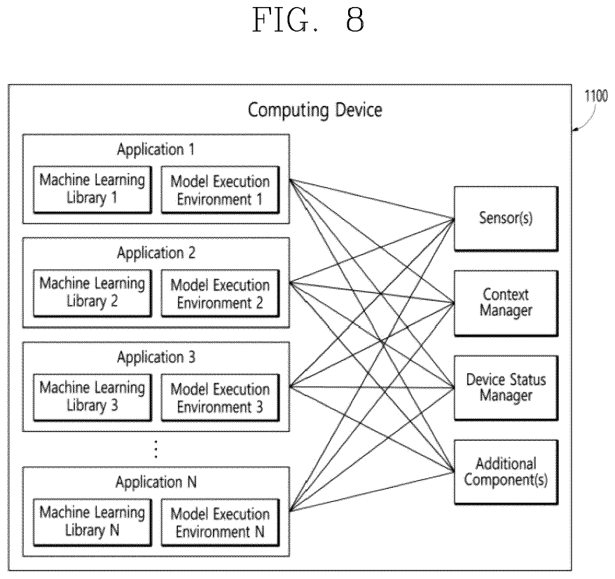

Meanwhile, FIG. 8 illustrates an example block diagram of a computing device (1100), which may be included in the user computing device (1010), the server computing device (1030), or the training computing device (1050), as one embodiment of the computing system (10000) in which the present invention may be implemented.

As shown in FIG. 8, the computing device (1100) may include at least one application (e.g., Application 1 to Application N), and each of the at least one application may include a machine learning library and a model execution environment for performing a control method and a training method of a machine learning-based kinetic typography video generation system.

Each of the at least one application included in the computing device (1100) may communicate via an Application Programming Interface (API) with one or more components within the computing device (1100), such as sensors, a context manager, a device state manager, or additional components.

In one embodiment, the at least one application may interface with device components by, for example, receiving sensor data or state data via a public or dedicated API, or transmitting prediction results to an output device.

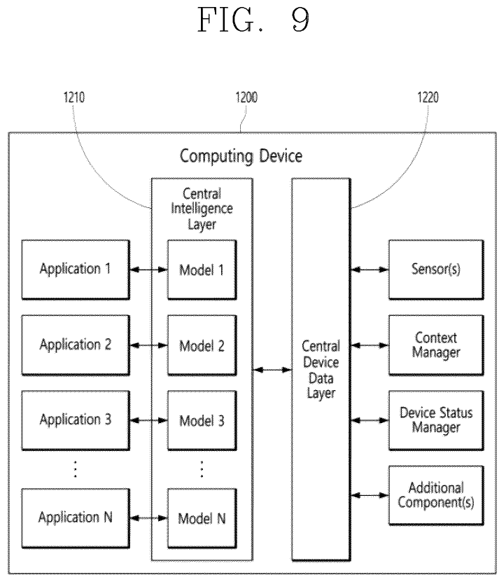

Meanwhile, FIG. 9 illustrates an example block diagram of a computing device (1200), which is one component of the computing system (10000) performing a control method and a training method of a machine learning-based kinetic typography video generation system, according to an embodiment of the present invention, from another perspective.

The computing device (1200) according to the present invention may include at least one application (e.g., Application 1 to Application N), and each of the at least one application may communicate with a central intelligence layer (1210). Each application may interact with a shared model within the central intelligence layer (1210) via an API (e.g., a common API).

The central intelligence layer (1210) may include one or more machine learning models and may either share them among multiple applications or provide them independently to each application. In one embodiment, the central intelligence layer (1210) may be integrated as part of the operating system or implemented as a separate logical layer.

Additionally, the central intelligence layer (1210) may communicate with a central device data layer (1220). The central device data layer (1220) may integratively store training target typography videos and other related data for kinetic typography video generation that are stored within the computing device (1200) and provide them as input data required for controlling and training the kinetic typography video generation system. Each device component (e.g., sensors, state managers, etc.) may communicate with the central device data layer (1220) via a private API or the like.

The technology described in the present specification may be implemented using a single computing device or multiple computing devices. A machine learning model (e.g., a kinetic typography video generation model) that performs the control method and the training method of the kinetic typography video generation system may be executed sequentially or in parallel on a single component or across multiple distributed components. The data store, machine learning models, and applications may be distributed and operated locally or over a network, and these components may be flexibly applied to various system architectures.

As described above, according to the kinetic typography video generation system and the control method thereof, and the learning method of the kinetic typography video generation system according to the present invention, by automatically generating a kinetic typography video using a kinetic typography video generation model, a user environment may be provided in which a kinetic typography video that matches the user's intent may be generated without requiring manual work by the user. That is, without requiring the user to perform manual processing, a high-quality kinetic typography video may be generated automatically, thereby enabling the user to generate a kinetic typography video matching the user's intent efficiently without wasting time or resources.

In addition, according to the kinetic typography video generation system, the control method thereof, and the learning method of the kinetic typography video generation system according to the present invention, by enabling dynamic movement and style transformation of multiple characters, a more sophisticated and flexible kinetic typography video may be generated.

Further, according to the kinetic typography video generation system, the control method thereof, and the learning method of the kinetic typography video generation system according to the present invention, by systematically separating and labeling static and dynamic effects, the kinetic typography video generation model may better understand the visual external appearance and movement of text, thereby generating a more sophisticated and flexible kinetic typography video.

In addition, according to the kinetic typography video generation system, the control method thereof, and the learning method of the kinetic typography video generation system according to the present invention, by training the kinetic typography video generation model using various captions along with the video, the kinetic typography video generation model may not only maintain temporal consistency but also more accurately express character-specific motion effects suitable for the text prompt.

Furthermore, according to the kinetic typography video generation system, the control method thereof, and the learning method of the kinetic typography video generation system according to the present invention, by utilizing the static caption, dynamic caption, and word caption, visual external shape and temporal motion may be more precisely controlled. Through this, it is possible to implement typography that is not a simple text video but is customizable, eye-catching, and high in deliverability.

That is, in the present invention, by dividing the text prompt into a static caption and a dynamic caption and respectively learning and processing them by separating spatial and temporal information, the readability of the text is improved and accurate motion expression becomes possible. As a result, customized typography video generation according to user requirements may be achieved, and even after generating the typography video, functionality may be provided to allow the user to flexibly modify text style, color, motion, and the like. Additionally, the model structure of the present invention enables harmonious combination of various information, providing effective visual expression for message delivery. Particularly, the present invention may generate typography videos capable of attracting viewers' attention and clearly delivering information in content such as advertisements, movie titles, and educational materials.

Meanwhile, the present invention described above may be executed by one or more processes on a computer and implemented as a program that may be stored on a computer-readable medium (or recording medium).

Further, the present invention described above may be implemented as computer-readable code or instructions on a medium in which a program is recorded. That is, the present invention may be provided in the form of a program.

Meanwhile, the computer-readable medium includes all kinds of storage devices for storing data readable by a computer system. Examples of computer-readable media include hard disk drives (HDDs), solid state disks (SSDs), silicon disk drives (SDDs), ROMs, RAMs, CD-ROMs, magnetic tapes, floppy discs, and optical data storage devices.

Further, the computer-readable medium may be a server or cloud storage that includes storage and that the electronic device is accessible through communication. In this case, the computer may download the program according to the present invention from the server or cloud storage, through wired or wireless communication.

Further, in the present invention, the computer described above is an electronic device equipped with a processor, that is, a central processing unit (CPU), and is not particularly limited to any type.

Meanwhile, it should be appreciated that the detailed description is interpreted as being illustrative in every sense, not restrictive. The scope of the present invention should be determined on the basis of the reasonable interpretation of the appended claims, and all of the modifications within the equivalent scope of the present invention belong to the scope of the present invention.

What is claimed is:

1. A learning method of a kinetic typography video generation system, the learning method processed by a computing device, comprising:
inputting a typography video to be trained into an encoder;
acquiring a latent vector for the video from the encoder;
inputting the latent vector into temporal-spatial processing blocks that process spatial information and temporal information;
injecting a static caption and a dynamic caption for text included in the video into the temporal-spatial processing blocks;
acquiring a latent vector reflecting the spatial information and a latent vector reflecting the temporal information from the temporal-spatial processing blocks;
inputting the latent vector reflecting the spatial information and the latent vector reflecting the temporal information into a decoder;
acquiring a final typography video for the input from the decoder; and
training a typography generation model using the final typography video and the typography video to be trained.

2. The learning method of claim 1, wherein the temporal-spatial processing blocks comprise a spatial block for processing the spatial information and a temporal block for processing the temporal information, and
the spatial block and the temporal block exist to form a pair.

3. The learning method claim 2, wherein the injecting comprises:
injecting the static caption describing the spatial information of the text into the spatial block; and
injecting the dynamic caption describing the temporal information of the text into the temporal block,
wherein the static caption includes a description of at least one of a visual external appearance of the text or a characteristic of a background included in the video, and
the dynamic caption includes a description of at least one of a motion, an appearance order, and a change pattern of the text according to a temporal change of the video.

4. The learning method of claim 3, wherein the spatial block comprises a spatial downsampling block and a spatial upsampling block, and
the temporal block comprises a temporal downsampling block and a temporal upsampling block.

5. The learning method of claim 3, wherein the injecting further comprises injecting a word caption for the text into the temporal-spatial processing blocks, and
the word caption includes a description of an overall structure and meaning of the text.

6. The learning method of claim 5, wherein the injecting of the word caption comprises:
specifying at least one block among the temporal-spatial processing blocks into which the word caption is to be injected; and
injecting the word caption into the specified block.

7. The learning method of claim 2, wherein the spatial block outputs a latent vector reflecting the spatial information through a preset spatial diffusion mechanism,
the temporal block outputs a latent vector reflecting the temporal information through a preset temporal diffusion mechanism, and
the decoder generates the final typography video by combining the latent vectors respectively output from the spatial block and the temporal block.

8. The learning method of claim 1, wherein the training comprises:
calculating a loss between the typography video to be trained and the final typography video generated by the decoder using a preset loss function; and
training the typography generation model such that the loss is reduced.

9. A kinetic typography video generation system, comprising:
a memory and at least one processor,
wherein the memory and the processor cooperate to:
input a typography video to be trained into an encoder;
acquire a latent vector for the video from the encoder;
input the latent vector into temporal-spatial processing blocks that process spatial information and temporal information;
inject a static caption and a dynamic caption for text included in the video into the temporal-spatial processing blocks;
acquire a latent vector reflecting the spatial information and a latent vector reflecting the temporal information from the temporal-spatial processing blocks;
input the latent vector reflecting the spatial information and the latent vector reflecting the temporal information into a decoder;
acquire a final typography video for the input from the decoder; and
train a typography generation model using the final typography video and the typography video to be trained.

10. The kinetic typography video generation system of claim 9,
wherein the temporal-spatial processing blocks comprise a spatial block for processing the spatial information and a temporal block for processing the temporal information, and the spatial block and the temporal block exist to form a pair.

11. The kinetic typography video generation system of claim 10,
wherein the memory and the processor cooperate to inject:
a static caption describing the spatial information of the text into the spatial block; and
a dynamic caption describing the temporal information of the text into the temporal block,
wherein the static caption includes a description of at least one of a visual external appearance of the text or a characteristic of a background included in the video, and
the dynamic caption includes a description of at least one of a motion, an appearance order, and a change pattern of the text according to a temporal change of the video.

12. The kinetic typography video generation system of claim 11,
wherein the spatial block comprises a spatial downsampling block and a spatial upsampling block, and the temporal block comprises a temporal downsampling block and a temporal upsampling block.

13. The kinetic typography video generation system of claim 11,
wherein the memory and the processor cooperate to inject a word caption for the text into the temporal-spatial processing blocks, and the word caption includes a description of an overall structure and meaning of the text.

14. The kinetic typography video generation system of claim 13,
wherein the memory and the processor cooperate to:
specify at least one block among the temporal-spatial processing blocks into which the word caption is to be injected; and
inject the word caption into the specified block.

15. A program stored in a non-transitory computer-readable storage medium, executed by one or more processes in an electronic device, wherein the program includes instructions to perform:
inputting a typography video to be trained into an encoder;
acquiring a latent vector for the video from the encoder;
inputting the latent vector into temporal-spatial processing blocks that process spatial information and temporal information;
injecting a static caption and a dynamic caption for text included in the video into the temporal-spatial processing blocks;
acquiring a latent vector reflecting the spatial information and a latent vector reflecting the temporal information from the temporal-spatial processing blocks;
inputting the latent vector reflecting the spatial information and the latent vector reflecting the temporal information into a decoder;
acquiring a final typography video for the input from the decoder; and
training a typography generation model using the final typography video and the typography video to be trained.

16. The non-transitory computer-readable storage medium of claim 15,
wherein the instructions, when executed by one or more processors, cause the one or more processors to utilize temporal-spatial processing blocks comprising a spatial block for processing the spatial information and a temporal block for processing the temporal information, and wherein the spatial block and the temporal block exist to form a pair.

17. The non-transitory computer-readable storage medium of claim 16,
wherein the instructions, when executed by one or more processors, cause the one or more processors to:
inject a static caption describing the spatial information of the text into the spatial block; and
inject a dynamic caption describing the temporal information of the text into the temporal block,
wherein the static caption includes a description of at least one of a visual external appearance of the text or a characteristic of a background included in the video, and
the dynamic caption includes a description of at least one of a motion, an appearance order, and a change pattern of the text according to a temporal change of the video.

18. The non-transitory computer-readable storage medium of claim 17,
wherein the instructions, when executed by one or more processors, cause the one or more processors to implement the spatial block comprising a spatial downsampling block and a spatial upsampling block, and the temporal block comprising a temporal downsampling block and a temporal upsampling block.

19. The non-transitory computer-readable storage medium of claim 17,
wherein the instructions, when executed by one or more processors, cause the one or more processors to inject a word caption for the text into the temporal-spatial processing blocks, and wherein the word caption includes a description of an overall structure and meaning of the text.

20. The non-transitory computer-readable storage medium of claim 19,
wherein the instructions, when executed by one or more processors, cause the one or more processors to:
specify at least one block among the temporal-spatial processing blocks into which the word caption is to be injected; and
inject the word caption into the specified block.
